(19) United States
(12) Patent Application Publication
(10) Pub. No.: US 2007/0226275 A1
(43) Pub. Date: Sep. 27, 2007

(54) System and method for transferring media

(76) Inventor: George Eino Ruul, Applecross (AU)

Correspondence Address: CARR & FERRELL LLP, 2200 GENG ROAD, PALO ALTO, CA, 94303, US

(21) Appl. No.: 11/586,213

(22) Filed: Oct. 25, 2006

Related U.S. Application Data
(60) Provisional application No. 60/785,655, filed on Mar. 24, 2006.

(51) Int. Cl. G06F 17/30

(52) U.S. Cl. 707/204

(57) ABSTRACT

Systems and methods for transferring an electronic media are provided. A command is received to transfer the media from a first location to a second location. In exemplary embodiments, a media provider is contacted to provide the media to the second location. A version of the media or a link to the media is then displayed at the second location. In one embodiment, the version of the media may entirely comprise generic information. Alternatively, the version of the media may comprise a media template that can be customized based on user preferences and/or media provider real-time information.

### CROSS REFERENCE TO RELATED APPLICATIONS

The present application claims the priority benefit of U.S. Provisional Patent Application No. 60/785,655, filed Mar. 24, 2006 and entitled “Dynamic and Interactive Advertising System,” which is herein incorporated by reference. The present application is related to co-pending U.S. patent application Ser. No. ______ entitled “System and Method for Providing Dynamic Media,” U.S. patent application Ser. No. ______ entitled “System And Method For Providing And Maintaining Dynamic Media,” U.S. patent application Ser. No. entitled “System and Method for Maintaining a History of Transferable and Updatable Media” all filed concurrently with the present application. The present application is further related to co-pending U.S. patent application Ser. No. 11/214,515 entitled “Managed E-Commerce Trading,” filed Aug. 29, 2005; U.S. patent application Ser. No. 11/250,996 entitled “E-Commerce with Direct Access to Real-Time Inventory,” filed Oct. 14, 2005; U.S. patent application Ser. No. 11/251,316 entitled “Managed E-Commerce Trading Environments,” filed Oct. 14, 2005; and U.S. patent application Ser. No. 11/258,419 entitled “Content Monitor,” filed Oct. 24, 2005, all of which are herein incorporated by reference.

### BACKGROUND OF THE INVENTION

1. Field of the Invention

The present invention relates generally to online media, and more particularly to systems and methods for providing transferable media.

2. Description of Related Art

The Internet has developed into a dominant force in the global business market. Media such as movie clips, sound or music clips, articles, essays, recipes, advertisements, and advice columns may be posted by media providers for consumers to view. Businesses may now sell products, deal with vendors, post advertisements, promote items, and conduct other business, activities via the Internet. For large businesses having large advertising budgets, frequently posting media to reach out to customers is relatively easy. Smaller businesses, however, may not have the capability to do the same.

Despite widespread advertising on the web, the media that a user sees while on particular websites is posted for a limited period of time. So if, for example, the user is too busy or not interested enough at the moment to investigate the media, the user may be unable to retrieve the media at a later time. For example, as Internet advertisements are frequently updated or changed by websites, it is often difficult for a user to find an advertisement that had been posted earlier. Therefore, the advertiser has lost a potential customer simply because the customer can not find the advertisement. Users may then purchase from a competitor whose advertisement is available when the user had more time or interest in the advertised product or service.

An additional shortcoming of current online media is that the media can not be easily referred by a user to another user. This “word of mouth” spread of information is valuable to vendors and businesses as it is extremely effective at changing consumer perceptions and generating sales. While a user may attempt to save the media and email the media as an attachment to another user, this process is unreliable and cumbersome. Alternatively, the user may try to send a link associated with the media. This method, however, often does not work as the media may change on a certain link. Likewise, a user may come across media and wish to make it available to a group of users who may be interested. Because transfers are difficult, a business may lose one or more potential contacts or customers simply because a user was unable to refer the media to another user.

As many of these prior art systems do not allow for storing and transferring of electronic media, there is a need for a system and method for storing and transferring electronic media.

### SUMMARY

Systems and methods for transferring an electronic media are provided. According to an exemplary method, a command is received to transfer the media from a first location to a second location. The first location may comprise a website, banner advertisement location, an e-mail communication, or any other location where media maybe stored or displayed. The command may be received by a transfer module in a user media engine of a user device.

In exemplary embodiments, data associated with the media is accessed, transferred, or copied from the first location by the transfer module. This data comprises, at least, a media identifier and a parent address. This data may further include static information associated with the media including logo, text, and graphics. The data may also comprise fields which can be populated with customized information.

A version of the media is then created at the second location. In one embodiment, the version of the media may entirely comprise generic information. In this embodiment, the media is not customizable to the user. Thus, the version of the media is a complete copy of the media at the first location.

Alternatively, the version of the-media may comprise a media template which can be customized based on user preferences and/or real-time information. A media provider data module may obtain real-time information from, for example, a vendor inventory database for incorporation into one or more fields. Other real-time information may comprise, for example, real-time images related to a news story, directory information, or weather information. Furthermore, a user preference module may customize the media with information associated with user preferences (e.g., location, language, etc.). In other embodiments, the media provider data module may receive a full version of the media based on user preferences. In other embodiments, the media provider module may receive a link to the media.

### BRIEF DESCRIPTION OF THE DRAWINGS

FIG. 1 is an online environment in which embodiments of the present invention may be practiced;

FIG. 2 is a block diagram of an exemplary online services server, according to one embodiment;

FIG. 3 is a block diagram of an exemplary user device comprising a core services module;

FIG. 4 is a block diagram of an exemplary media engine;

FIG. 5A is a block diagram of an exemplary media;

FIG. 5B is an illustration of an example media;

FIG. 6A is a flowchart of an exemplary media transfer method;

FIG. 6B is a flowchart of an alternative media transfer method; and

FIG. 7 is a flowchart of an exemplary transfer method initiated by a user.

### DESCRIPTION OF EXEMPLARY EMBODIMENTS

Embodiments of the present invention provides systems and methods for transferring media. In some embodiments, the transfer is via a “drag and drop” command. “Drag and drop” as utilized herein may refer to selecting and moving a copy or version of the transferable media to a designated location, generating a copy of the transferable media at the designated location, or creating a direct link to the transferable media at the designated location. Embodiments of the present invention allow a plurality of users (e.g., consumers or customers) to drag and drop electronic media onto desktops of their computing devices, and transfer the media between each other. In one embodiment, the transfer occurs in a real-time environment, such as a real-time e-commerce environment. This allows users to “save” media for a more convenient time and/or refer the media to other users.

Unlike prior art systems, a user can save media, such as a banner advertisement appearing on a website, to the user's desktop and continue using a network (e.g., “surfing” the Internet) after only a minor interruption. Likewise, embodiments of the present invention also allow the user to transfer media to another user. Further embodiments allow a media provider to customize information in the media based on a profile or preferences of the user.

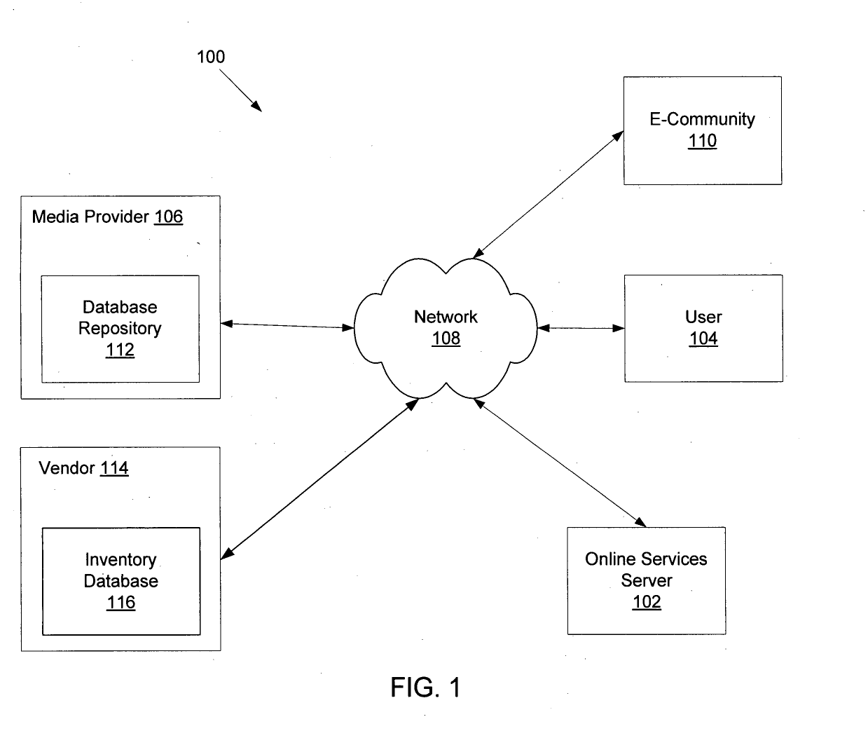

FIG. 1 shows an exemplary environment 100 in which embodiments of the present invention may be practiced. The environment 100 comprises an online services server 102, at least one user 104 (e.g., an individual on the network 108), and at least one media provider 106 all coupled for communication via a network 108. In exemplary embodiments, the network 108 may be the Internet, wide area network, local area network, or any other type of communication network. The online services server 102 and a computing device of the user 104 will be discussed in more detail below. In some embodiments, one or more optional e-communities 110 (i.e., groups of users sharing a common interest) may also be present in the environment 100.

The present environment 100 allows a plurality of users 104, media providers 106, and optional e-communities 110 to interact with each other, including dragging and dropping or transferring media over the network 108. The interactions may result in online transactions or exchange of information.

In the present embodiment, the media provider 106 provides media to the environment 100. The media provider 106 may comprise news outlets, content providers, marketing firms, advertising firms, or any entity which may manage online advertising and marketing strategies. The media may be presented, for example, on webpages, pop-ups, and banner ads. Additionally, the media may be presented in e-mail communications or shared between members of the environment 100 (e.g., users 104, media providers 106, and optional e-communities 110). Updates to the media may be provided via a database repository 112. In exemplary embodiments, the database repository 112 is a real-time database comprising up-to-the-minute data. The database repository 112 may also comprise a media database comprising different media the media provider 106 may provide.

Media may comprise any item of information found on the network 108 that is configured to function with embodiments of the present invention. For example, the media may be an advertisement or news article that is identified as one that can function in the environment 100. The identifier may be a symbol or any other indicator that the media is operable in the environment 100.

In a specific embodiment, the media provider 106 is a vendor 114. In exemplary embodiments, the media from the vendor 114 (e.g., advertisement) is updatable with vendor information from a database repository comprising an inventory database 116. The exemplary inventory database 116 is a current, real-time database maintained by the vendor 114, which comprises inventory information including inventory amount and pricing. In exemplary embodiments, the inventory database 116 is located at the vendor's location and tracks pricing and movement of the vendor's inventory. In some embodiments, a media provider 106 may be coupled to the vendor 114 to provide the media on behalf of the vendor 114.

In exemplary embodiments of the present invention, the members of the environment 100 (e.g., communicating entities) communicate over the network 108 using a specialized GUID-over-IP transport mechanism. The specialized transport mechanism allows the communicating entities to be coupled through a network of internal and external routers, proxies, and firewalls without requiring reconfiguration of various communications equipment. Routing management may be used to control pathways taken by the communicating entities. This may be an important feature for communicating entities that are sensitive about the content of the media. Additionally, load balancing and N-tier construction allow for efficient scale out rather than scale up implementations.

The coupled computing devices of the members of the environment 100 each comprise a core services module which allows operation of embodiments of the present invention and for customization. The core services module will be discussed in more detail below.

In exemplary embodiments utilizing a standard browser, when a media is selected, a script such as a Java script (e.g., a Visual Basic script) embedded into a HTML section of the media is activated (e.g., JAVA functions or active X control). This script interacts with the core services module at the user 104 device, which recognizes that the media has a particular media identifier and a parent identifier. A connection is then made via the script and the core services module to the media provider 106 identified by the parent identifier, which can then provide instructions and data to display a version of the media at the user 104 device. The data may allow for an exact duplicate of the media the user 104 selected or a customized version of the media. While the result may appear to be a “drag and drop” in these embodiments, in reality, it is an instruct and recreate process. In a further embodiment, the media as displayed on a web page, for example, is extracted and utilized to display the media on the user's desktop, even if the user is offline at that time. However, any action based on a real-time link is curtailed until reconnection occurs.

In an alternative embodiment utilizing an online services application, a version of the media can be “copied and pasted.” That is, every component that is embedded in the media can be copied and moved over to the designated location.

In yet further embodiments, the media may literally be “dragged and dropped” from a first location to a second location (i.e., taken from the first location and dropped onto a second location). For example, a media may be dragged from the desktop of the user 104 to an e-mail to be sent to another user. In these embodiments, the trigger or select event is a “drag and drop” command received from the user 104.

In a further embodiment, a media manager (not shown) may be coupled to the network 108 of the online system of FIG. 1. The media manager arranges for the vendor 114 to pay a fee or commission to the e-community 110 or user 104, for example, for sales generated by advertisements/media transferred by the e-community 110 or users 104.

While some of the above embodiments describe a media constructed in, or containing at least a section of, HTML, alternative embodiments of the media may be constructed using other formats. For example, the media may be constructed using Macromedia's Flash, XML using XSLT, or any other potential construct language that can trigger the select event. The “select” event may cause the media to be transferred, copied, or dropped, or may cause a connection to the media provider 106 to be established.

It should be noted that the environment 100 of FIG. 1 is exemplary. Alternative embodiments may comprise more or fewer components. For example, more than one online services server 102 may be provided (e.g., regionally based). Furthermore, any number of users 104, media providers 106, e-communities 110, and vendors 114 may be coupled in communication in the environment 100 at any time.

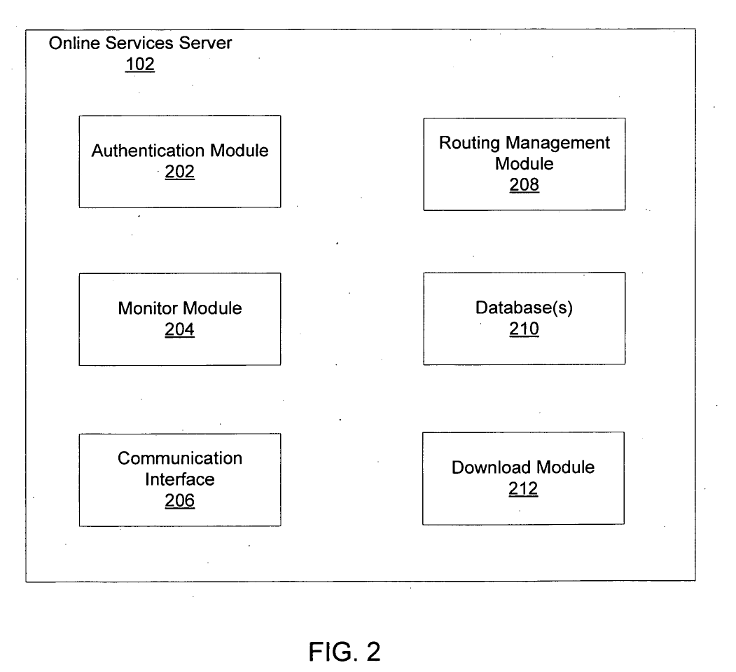

Referring now to FIG. 2, the online services server 102 is shown in more detail. In certain embodiments, the online services server 102 may comprise an e-commerce server. In exemplary embodiments, the online services server 102 comprises an authentication module 202, a monitor module 204, a communication interface 206, a routing management module 208, at least one database 210, and a download module 212. In further embodiments, the database 210 may comprise a plurality of databases, each storing designated data. For example, the optional online services server 102 may comprise an authentication database (e.g., containing user information), a monitor database (e.g., storing transaction information), a history database (e.g., tracking updatable and transferable media), and an online services application database (e.g., storing application plug-ins and modules for e-commerce, e-community, or other applications that may be accessed and downloaded onto the user 104 and vendor 114 devices). In alternative embodiments, the database 210 is located outside of the online services server 102 but is coupled thereto. It should be noted that the online services server 102 may comprise other components not relevant to the functionalities of embodiments of the present invention.

The exemplary authentication module 202 authenticates users 104, media providers 106, e-communities 110 (e.g., an administrator for the e-community 110), and vendors 114. When these members first register with the online services server 102, the members provide data such as a user name, password, and contact information. This information is then stored in the database(s) 210.

Subsequently, authentication may occur seamlessly and unobtrusively to the members. In one embodiment, the authentication process comprises verifying the user name and password supplied by the member with those stored in the database(s) 210. Alternative methods for authenticating members may be utilized, such as, for example, verifying IP addresses in communications sent between members. The authentication information may be received via the communication interface 206. The authentication module 202 then compares the received authentication information to authentication information stored in the database(s) 210. As such, members accessing and utilizing the environment 100 are known to the online services server 102, and based on permissions associated with the member, are enabled to interact with other members. In some embodiments, the authentication module 202 allows for transfer of media.

In alternative embodiments, the authentication module 202 is optional or not required in order for embodiments of the present invention to be practiced. In these embodiments, a user 104, media provider 106, e-community 110, and/or vendor 114 does not need to be registered/authenticated in order to support media functionalities. For example, registration/authentication may be performed automatically without the user 104 being required to submit any personal information. In these embodiments, each media is an instantiation of a node of a closed/private community comprising the media provider 106 and all media (from the media provider 106) currently in existence. The media provider 106 hosts the ‘authentication process’ and it may be different for each media accessed by the user 104. Thus, an instantiation is authenticated each time as distinct from the user 104 or computing device, itself.

As such, the authentication process may occur during an initial connection with the system (e.g., login at a start of a session). In alternative embodiments, authentication may occur at other times, such as when the user 104 interacts with a media. In further embodiments, the user 104 does not need to be authenticated or logged into the online services server 102 in order to interact with the media (e.g., view, transfer, or receive updates to the media).

In some embodiments, authentication of the user 104 allows for customization of media viewed by the user 104. Because the user 104 is now logged in with the online services server 102 and/or the media provider 106, updates from the media provider 106 may be provided to the authenticated user 104. Additionally, the online services server 102 may monitor media viewed by each user 104 and track actions associated with each user 104 with regards to media (e.g., transferring a media to other users 104, purchasing via the media, etc.), and maintain a history of the media.

In some embodiments, the monitor module 204 monitors media that has been transferred onto a user's 104 desktop or media that has been transferred between users 104 or within e-communities 110. For example, the online services server 102 may receive copies of, or intercept, communications containing-media being sent in packets between vendors 114, media providers 106, e-communities 110, and users 104. The monitor module 204 monitors the media via these packet copies.

The routing management module 208 provides routing instructions that allow for control of pathways taken by, for example, communications containing transferred media. In one embodiment, the use of routing instructions allows the system to monitor the communications by routing a copy of the communication containing the media being transferred to the online services server 102.

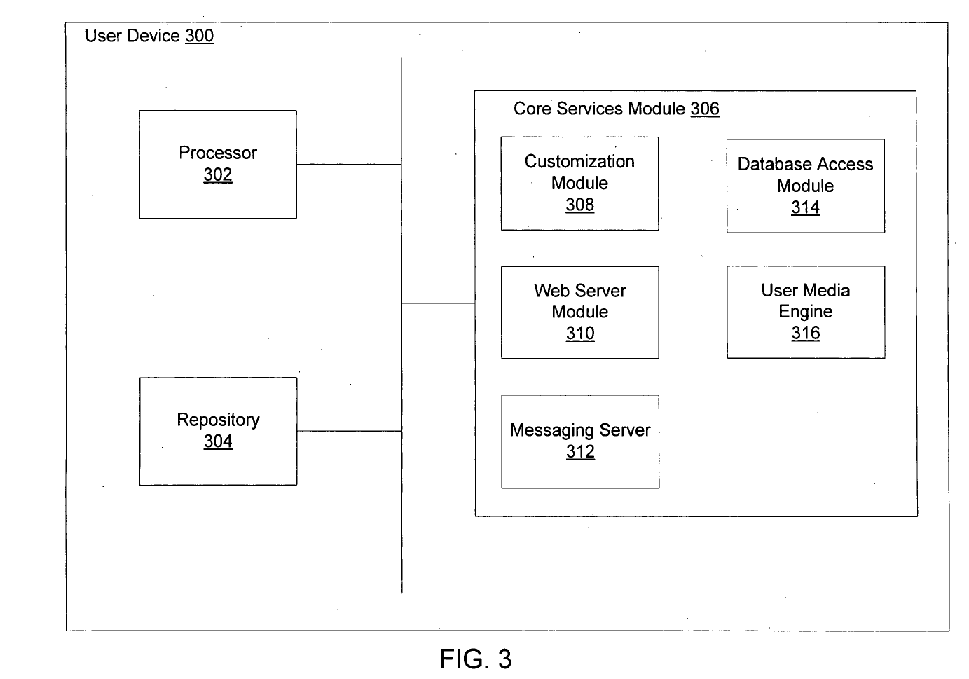

The online services server 102 further comprises a download module 212. The download module 212 provides applications and components (e.g., from the online services application database) which create a core services module, as described in more detail in FIG. 3, at the device of the user 104, the media providers 106, the e-community 110, and/or the vendor 114. In alternative embodiments, components of the download module 212 may be embodied, for example, on a CD-ROM for easy distribution. The download module 212 may provide a license agreement, registration, and product updates. In some embodiments, the download module 212 will distinguish a downloading member as a user 104, media provider 106, e-community 110, or vendor 114, so as to provide a different version of the core services module component to each type of member. In some embodiments, the core 'services module components may be the same for all members, while alternative embodiments may comprise different components. Once downloaded by the member, the core services module is configured to meet the needs of the downloading member.

Referring now to FIG. 3, an exemplary user device 300 is shown. The user device 300 is operated by the user 104 to access the network 108 and may comprise a digital device, a mobile phone or device (e.g., thin clients), or any other wired or wireless device that is enabled to receive information via the network 108. The exemplary user device 300 comprises a processor 302, a repository 304 or other data storage, and a core services module 306 which may be stored in memory or in the repository 304. In exemplary embodiments, the core services module 306 is downloaded from the online services server 102 and installed on the user device 300. Alternative embodiments may comprise more, less, or functionally equivalent components. For example, some of the components of the exemplary user device 300 may be optional.

In some embodiments, the user core services module 306 is downloaded from the online services server 102 via the download module 212 and is seamlessly integrated into the user computing device 300. In exemplary embodiments, the core services module 306 is downloaded when an online services application is downloaded. For example, the core services module 306 is downloaded when a user 104 downloads an e-commerce application or an e-community application as described in related U.S. patent application Ser. No. 11/214,515 entitled “Managed E-Commerce Trading,” and U.S. patent application Ser. No. 11/251,316 entitled “Managed E-Commerce Trading Environments,” which are incorporated by reference. That is the core service module 306 is an inherent part of all online services applications provided by the online services server 102. Once the core services module 306 is installed on the user computing device 300, regardless of whether an online services application is running, interaction with media is enabled. In some embodiments, the running of an online services application will enable further functionalities of the media, such as the “drag and drop” function. In alternative embodiments, the core services module 306 may be downloaded separate from any online services application (e.g., when the user 104 first interacts with a media).

The core services module 306 may comprise a customization module 308, a web server module 310, a messaging server module 312, a database access module 314, and a user media engine 316. In some embodiments, the core services module 306 may also comprise a specialized browser technology optimized for communication using the Internet without depending on existing HTML/XML browser technology.

In some embodiments, the customization module 308 maintains and updates a list of user preferences including preferred media providers 106 or vendors 114 as well as established relationships with e-communities 110. This list may be received directly from the user 104 via, for example, responses to a survey or other data. Additionally, the customization module 308 may automatically populate the list based on media that the user 104 has dragged and dropped, reviewed, purchased from, or transferred in the past, including media that has been received by the user 104 from other users 104 or transferred within the e-communities 110 that the user 104 belongs to. In some embodiments, the user preference list maintained and updated by the customization module 308 is stored in the repository 304.

A web server module 310 allows web-based interactions with other system installations. Additionally, the web server module 310 may include messaging or Voice-over Internet Protocol (VoIP) technology.

An exemplary messaging server 312 ensures robust communication with other community members such as other users 104, vendors 114, media providers 106, or e-communities 110. The exemplary messaging server 312 may receive and process a command from the user 104 to transfer the media to another user 104 or to share the media within the e-community 110. Additionally, the messaging server 312 may provide communication to the media provider 106 via a link associated with the media to a media provider's website or using Voice over Internet Protocol (VoIP), as will be discussed in more detail below.

In some online services application enabled embodiments, the database access module 314 provides access to real-time information and updates in the media provider's database repository 112 or vendor's inventory database 116 such as updated news, directory information, inventory, pricing, and the like. This information may be used by the user media engine 316 to update media to reflect remaining inventory or pricing, for example. In alternative embodiments, the data access module 314 is optional or not required.

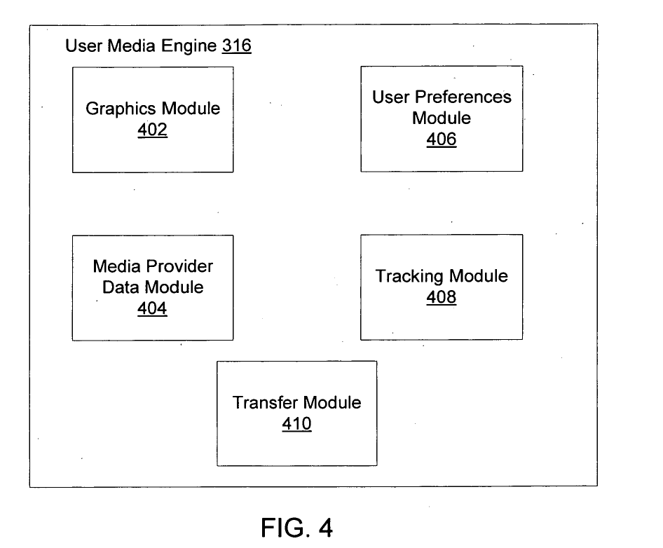

The user media engine 316, which is described in more detail in connection with FIG. 4, is configured to facilitate interactions of the user 104 with the media, including viewing, transferring, and locally storing the media.

Referring now to FIG. 4, a block diagram of the exemplary user media engine 316 is shown. In various embodiments, the user media engine 316 may facilitate the transfer of media onto the user's desktop, customization of the media, and/or transfer of the media to other users 104. The media engine 316 may comprise a graphics module 402, media provider data module 404, user preference module 406, tracking module 408, and transfer module 410. In alternative embodiments, the media engine 316 may comprise more, less, or functionally equivalent modules.

The exemplary graphics module 402 processes data, including static data, in order to generate a graphical representation of the media at an indicated location. The static data may include a media provider's logo, text or images, and an area of the media. In embodiments where the media is customizable, the graphics module 402 uses the static data to create a template. The graphics module 402 then incorporates media provider 106 and user 104 information, according to user preferences, into the template to generate a customized copy of the media.

In embodiments with customizable media, the exemplary media provider data module 404 is configured to interact with the media provider 106 in order to customize the media. According to exemplary embodiments, the media is customized by the media provider 106 based on user preferences. In some embodiments, the selection of a media (e.g., “drag and drop” or activation of a link on a dynamic media) acts as a trigger for the media provider data module 404 to communicate user preferences, which may include past behavior, to the media provider 106 in order to receive a copy of the dynamic media that has been customized to the user 104.

Alternatively, the media provider 106 may request the user preference information from the media provider data module 404. The media provider data module 404 may transmit a list of preferences from the user preferences module 406 which the media provider 106 processes to generate a customized version of the media. The media is then received by the media engine 316 (e.g., via the media provider data module 404) for display. For example, if a user has purchased a travel package to Europe from the media provider 106 in the past, the media provider data module 404 may send this past behavior information to-the media provider 106. The media provider data module 404 may then receive data limited to a selection of books within a European travel genre in a customized version of the selected media.

In alternative embodiments, the media provider data module 404 receives or obtains-data from the media provider 106 and merges the data with the static data. In some embodiments, the media provider data module 404 may select data from a larger set of data received from the media provider 106. For example, if a user's language preference is Spanish, the media provider data module 404 may select a Spanish-language version of the media instead of an English version. The selected data is then merged with the static data to generate the customized version of the media at the user computing device 300.

In other embodiments, the media provider data module 404 may receive a link to a copy of the media from the media provider 106. As such, no actual version of the media (e.g., media data) may be received by the user 104. The link may comprise an HTML address or a feed such as an RSS feed, an Atom feed or the like. In these embodiments, when the user clicks or otherwise activates the link, the media provider data module 404 communicates with the media provider 106 to facilitate display of a version of the media to the user 104.

In customizable media embodiments, the user preferences module 406 accesses the list maintained by the customization module 308 to determine one or more user preferences to incorporate into the media template or to send to the media provider 106. For example, a user's geographic location may be used to display a map to the nearest store of a vendor 114. In a further example, the user's geographic location may be used to obtain local pricing information from the vendor 114. In this example, the user preference module 406 works with the media provider data module 404 to obtain the pricing information from the inventory database 116. The user preference module 402 then incorporates the user information into the media.

In alternative embodiments, the media may not be customized to the user 104. In these embodiments, the data received by the media provider data module 404 is comprised of static media data, and the user preference module 406 is not required.

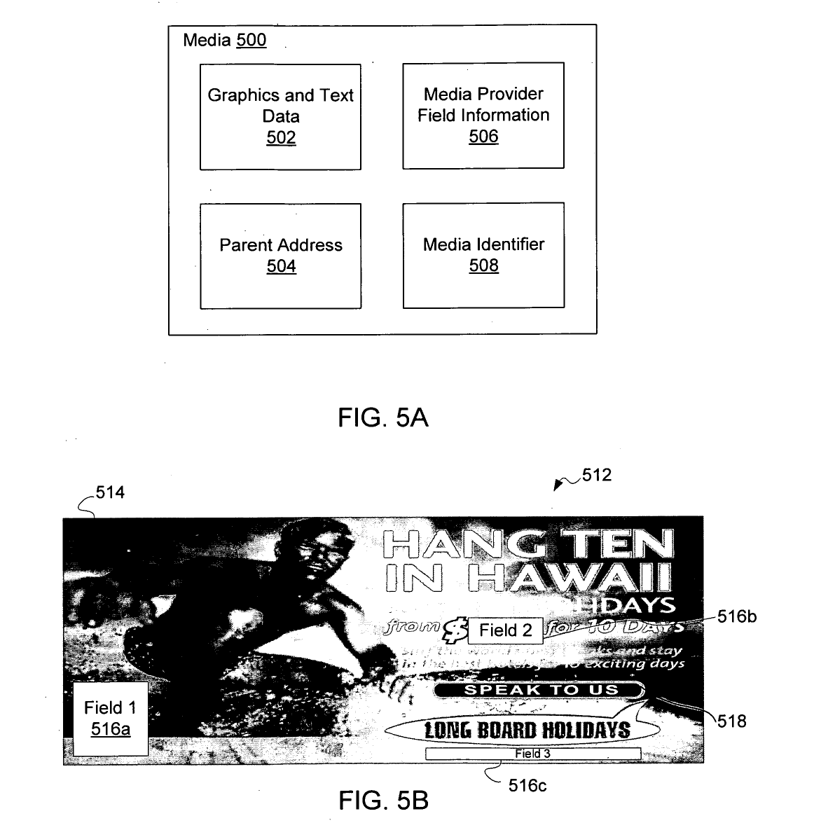

The exemplary tracking module 408 maintains a history of one or more media that interacts with the media engine 316 (e.g., created, transferred, viewed, etc.). After each subsequent update, customization, or transfer of the media, the tracking module 408 transmits data related to the update, customization and/or transfer of the media to a history database (e.g. database 210 of FIG. 2, the database 304 of FIG. 3, and/or a database at the vendor 114 or media provider 106 associated with the media). The tracking module 408 may also create a new media identifier each time the media changes or is transferred. Media identifiers will be discussed in detail in connection with FIG. 5A and FIG. 5B.

The exemplary transfer module 410 manages movement of media. For example, when the media is first dragged and dropped onto the desktop, the transfer module 410 receives a command to copy the media (e.g., the media is selected from a webpage or other location) and an indication of a location on the desktop where a copy of the selected media should be placed after generation by the graphics module 402 (e.g., dragged from the webpage or other location and dropped at the location on the desktop). The transfer module 410 may also aid the media provider data module 404 to communicate with the parent of the media. For example, when a script is activated on a selected media, the transfer module 410 recognizes the media identifier and parent identifier, and initiates a connection with the media provider 106 to obtain a copy of the selected media. In further examples, the transfer module 410 moves copies of the selected media to email communications or websites (e.g., a website of an e-community 110) so that the user 104 may share the media with others.

In alternative embodiments, more, less, or functionally equivalent modules may comprise the media engine 316. For example, the user preferences module 406 and/or the media provider data module 404 may be functionally combined with the graphics module 402 to form a single module. Furthermore, the media provider data module 404 and user preference module 406 may be optional.

Referring now to FIG. 5A, a block diagram of an exemplary media 500 is shown. A version of the media 500 can be “dragged and dropped” onto the user's 104 desktop or transferred to another user. Although the media 500 may not actually be dragged from one location and dropped to a second location, the operations of the various components of the core services module 306 function to make it appear as a simple drag and drop. In some embodiments, the copy of the media 500 may additionally be customized to the user preferences or updated as vendor inventory changes. The media 500 (or copy of the media 500) comprises graphics and text data 502, a parent address 504, optional media provider field information 506, and a media identifier 508.

The exemplary graphics and text data 502 includes parts of the media 500 that are static (i.e., not customized or updated). The static data may include the media provider's logo, fixed text or images, and dimensions of the media 500. In exemplary embodiments, the static data includes generic media provider data that is not customized to any user 104. If the media 500 is not customizable, then the graphics and text data 502 will comprise the entire media. Alternatively, the,graphics and text data 502 may include metadata about fields in which the optional media provider field information 506 is merged for a customizable media.

The parent address 504 is an identifier indicating a media provider 106 and contact information for the media provider 106. The media provider 106 may be a news provider, an online magazine or website, vendor 114, or other publisher of online content. In some embodiments, when the media is transferred, the user media engine 316 relays a message to the media provider 106 using the parent address 504 so that the media can be updated or customized to the recipient.

The optional media provider field information 506 comprises information transferred to the user 104 from the media provider 106 or the vendor 114, and in some embodiments, directly from the vendor's inventory database 116. The media provider field information 506 includes information used to customize or update the copy of the media 500 when the media 500 is dragged and dropped or transferred to another user. The media provider field information 506 may be transferred with the media 500, or alternatively, a set of field information may be transferred with the copy of the media 500. The media provider data module 404 may then select the field information 506 from the set according to the user preferences as discussed herein.

The media identifier 508 is used to identify a specific version of the media 500 that the user 104 views due to customizing or updating of the media 500. The tracking module 408 uses the media identifier 508 to maintain a history of the media 500. The media identifier 508 may also change, for example, when the media 500 is dragged and dropped by the user 104 and when the media 500 is received by another user after being transferred.

Referring now to FIG. 5B, an example media 512 is shown. In this example, the media is an advertisement from a vendor 114. The graphics and text data 502 is shown as media body 514 having optional fields 516 and an optional link 518. The media body 514 has a length dimension and a width dimension dictated by the graphics and text data 502. The graphics and text data 502 may also include image, text, and designated locations and dimensions for optional fields 516. In one embodiment, the graphics and text data 502 comprises the entire media.

The media body 514 may also comprise an optional link 518 configured to activate the communication interface 510 when a user 104 activates the link 518. The link 518 provides an alternate way to contact a media provider 106. For example, when the user 104 clicks the link 518, a real-time interaction with the media provider 106, such as through online messaging or VoIP, may be provided.

In further embodiments, the optional fields 516 are components of the media 512 that may be updatable or customizable. In customizable media embodiments, after a copy of the media 512 is dropped onto the desktop or received from another user 104, these fields 516 are customized to the user 104. Additionally, as inventory, pricing change, or other information change, some of these fields 516 may be updated. The fields 516 may each display a piece of field information 506 according to metadata associated with each field. For example, field 1, 516a, may display special promotions or remaining inventory in the vendors' 114 inventory database 116. Field 2, 516b, may display price information. In exemplary embodiments, the price information is a current price as obtained from the vendor's inventory database 116. Finally, field 3, 516c, may display vendor contact information. The fields may be used for different information in other types of media 500. For example, recipes may include fields to indicate low fat or low sugar variations. News stories may add fields 516 as news events develop to provide continuous coverage of events or a local perspective. Any number of fields 516 may be embodied in the sample media 512.

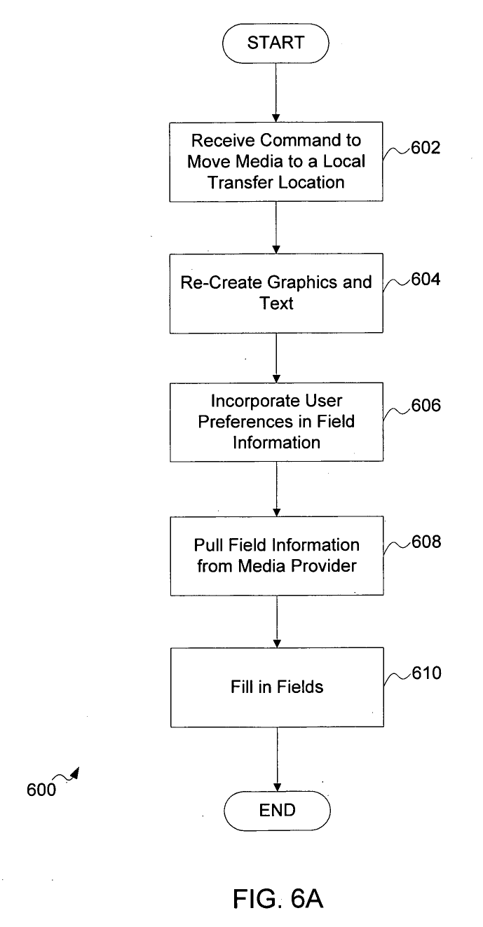

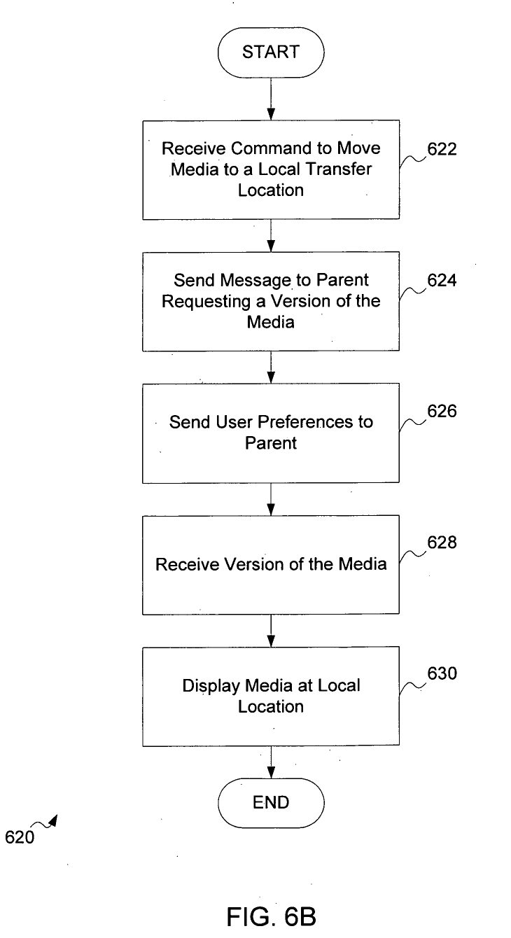

Referring now to FIG. 6A, a flowchart 600 of an exemplary transfer method initiated by a user 104 is shown. This method allows users 104 to save a copy of a media 500 from a webpage, banner (advertisement) location on a website, pop-up, or e-mail communication, for example, to a desktop or other location. The user 104 is able to later view the copy of the media 500 or activate a link to the media 500 at a more convenient time, especially if the user 104 is busy at the time or is only mildly interested. This provides increased convenience for users 104 and more effective Internet advertising or information dissemination for the media providers 106 and vendors 114.

In step 602, a command to transfer media 500 to a local transfer location is received from the user 104. In some embodiments, the command is received by the transfer module 410. For example, when a script is activated on a selected media, the transfer module 410 recognizes the media identifier and parent identifier, and initiates a connection with the media provider 106 to obtain a copy of the selected media. Alternatively, the command may be received from the user 104 when the user 104 copies and moves the media 500 or by dragging and dropping the media 500 from an Internet website, an email, a pop-up, or any other source which may provide media to the local transfer location. In exemplary embodiments, the local transfer location is the desktop on the user device 300. Alternatively, the local transfer location may be a dedicated file such as a “My Media” file or a calendar entry in a scheduling program. Furthermore, the user 104 may be able to categorize the media 500 within the transfer location, for example, as “vacation photos” or “grocery coupons.” The local transfer location may be accessible to the user 104 on more than one device such as a personal laptop and a mobile telephone. In further embodiments, the media 500 may be transferred to alternative transport locations such as an e-mail communication or another website (e.g., an e-community 110 website).

In step 604, the media engine 316 re-creates graphics and text in the transferred/copied media. In exemplary embodiments, the graphics and text data 502 is received by the graphics module 402 to create the media body 512. In some embodiments, the media body 512 may include fields 516. The fields 516 may include generic information, customized user information, and/or real-time, customized media provider information (e.g., if the media provider 106 is a vendor 114, current inventory and pricing information). In embodiments comprising non-customizable media, the fields only comprise generic information. Alternatively, the media engine 316 may receive the media from the media provider 106 or the vendor 114 that is already customized to the user 104.

In optional step 606, the user preferences module 406 incorporates user information 504 in the fields 516 of the media 500. The user information 504 is accessed by the user preference module 406 from the database 210 via the user preference module 406 or from any other source comprising user preference information. In an alternative embodiment, the user information may be sent to the media provider 106 by the user preference module 406 where the actual field information 506 may be generated and incorporated into the media and delivered to the user 104. In a yet further alternative embodiment, the user preference module 406 may select field entries from a list of entries from the vendor 114 or media provider 106 based on user preferences. For example, the user preference module 406 may select Spanish from the user 104 whose preferences indicate Spanish is their native language. In embodiments not including step 606, a generic set of field information 506 may be included in the media 500.

In step 608, the media provider data module 404 pulls field information 506 from the media provider 106 or the vendor 114 (e.g., inventory database 116). For example, the field information may comprise current inventory, pricing, location-specific information, or any other data from the vendor's inventory database 116. In exemplary embodiments, the media provider data module 404 receives a full version of the media 500 that has already been customized at the media provider 106. In some embodiments, the field information may be sent in response to user preferences. Alternatively, information may be selected from a set of information associated with the media by the user preferences module 406. For example, if the user 104 is in California, the field information may include California sales tax in the current price. The field information may be generic to more than one user 104. It should be noted that the media provider information may be updated at any time. The media provider data module may receive field information via a feed such as an RSS feed or an Atom feed.

In step 610, the media engine 316 fills in the fields 516 with the field information 506. The copy of the media 500 is now available to the user 104 at the local transfer location. The field information 506 may later be updated or customized until the media 500 expires or the user 104 deletes the media 500 from the local location. It should be noted that the steps 604, 606, 608, and 610 may be performed simultaneously or in a different order in alternative embodiments.

Referring now to FIG. 6B, a flowchart 620 of an alternative transfer method initiated by a user 104 is shown. Unlike the method illustrated in FIG. 6A, the transfer command acts as a trigger for the vendor 114 or the media provider 106 to transmit a version of the media 500 to the user 104.

In step 622, the transfer module 410, in some embodiments, receives a command from the user to move a copy of the media 500 to a local transfer location. The command may comprise dragging the media 500 to a transfer folder, clicking on the media 500 using a pointer or cursor, selecting an option to transfer the media 500 to a local transfer location, or other user input. According to various embodiments, this step is substantially similar to step 602.

In step 624, the transfer module 410 or a script in the media 500 transmits a message to the parent address 504 requesting a version of the media 500. The script in the media 500 may include the parent address 504 or the media provider field information 506. In exemplary embodiments, the script may comprise a Java® code or an ActiveX® control.

In optional step 626, the customization module 308 or the user preferences module 406 transmits user preferences to the parent address 504. In some embodiments, the parent address 504 may request specific user preferences. In other embodiments, a standard set of user preferences may be automatically transmitted to the parent address 504.

In step 628, the user 104 receives a version of the media 500. If the user preferences have been transmitted to the user, the media may be customized accordingly. Alternatively, if no preferences are received or the media provider 106 does not customize the media 500, a generic version of media 500 may be transmitted. The media is then displayed at the local location in step 630.

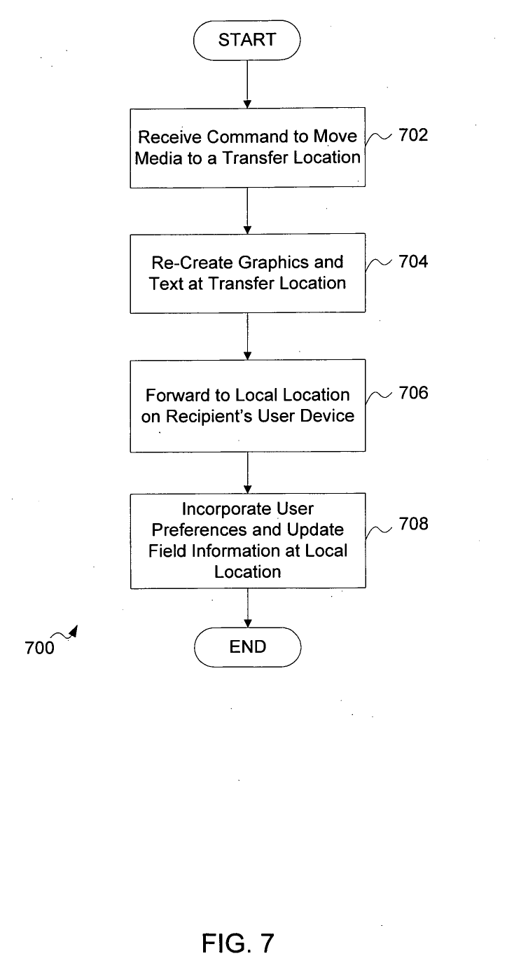

Referring now to FIG. 7, a flowchart 700 of an exemplary transfer method initiated by the user 104 is shown. This method allows users 104 to transfer the media 500 from the local location where the copy of the media 500 is saved/displayed to another user. The ability to transfer the media 500 provides the user 104 an ability to easily refer the media 500 to another user 104 or an e-community 110. The vendor 114 and the media provider 106 also benefit by reaching a wider audience.

In step 702, the transfer module 410 receives a command to move the media 500 from the local location to a transfer location from which a copy of the media 500 is forwarded to the recipient's user device 300. The command may be initiated by the user 104 dragging and dropping the media 500 into a transfer location such as an e-mail or onto a webpage. In alternative embodiments, the command comprises instructions to copy the media 500 from the local location and paste the media 500 to a transfer location. The transfer location may comprise a location on the user's 104 desktop, an e-mail communication, or location on a website, for example. In some embodiments, the transfer location may include or be associated with a menu for selecting a recipient to receive the media 500. The recipient can be selected from a list, such as an address book, or otherwise received as an input. The recipient can be identified by a login name, an email address, a nickname, a URL, or other identifier.

In step 704, the media engine 316 re-creates the graphics and text of the media 500 to generate the media body 510 at the transfer location. In exemplary embodiments, the graphics module 402 copies the graphics and text data 502 from the local location and moves the copy to the transfer location. The fields 516 may include generic media provider field information 506, or be left blank (e.g., to be filled in by the recipient's user preferences module 406).

In step 706, the copy of the media 500 at the transfer location is forwarded to a local location on the recipient's user device 300. For example, the copy of the. media 500 may be sent to the recipient in an e-mail communication. The recipient can now view their copy of the media 500. In some embodiments the vendor field information 506 in the fields 516 is generic to all users 104. In other embodiments, the media provider field information 506 may be customized or updated based on user preferences or vendor inventory.

In step 708, the media engine 316 on the user device 300 of the recipient incorporates the recipient's user preferences and updates the copy of the media 500. The recipient can now view the copy of the media 500 where the field information 506 in the fields 516 is specific to the recipient. It should be noted that the steps 706 and 708 may be performed substantially simultaneously so that the copy of the media 500 received is customized substantially upon receipt.

While embodiments of the present invention have been described above in reference to online, electronic media 500 in an online services environment, embodiments of the present invention may also be practiced in other environments. For instance, embodiments of the present invention may be practiced in an e-community 110 whereby members can exchange items. For example, a media for stamp trading may be exchanged among members of a stamp collecting e-community. The media may be updated as trades occur (e.g., inventory may change).

In further embodiments, the user 104 may drag and drop or transfer a media directly from a website or pop-up into an e-mail communication or another website without locally storing a copy (e.g., on the user's desktop).

The above-described functions and components can be comprised of instructions that are stored on a storage medium. The instructions can be retrieved and executed by a processor. Some examples of instructions are software, program code, and firmware. Some examples of storage medium are memory devices, tape, disks, integrated circuits, and servers. The instructions are operational when executed by the processor to direct the processor to operate in accord with embodiments of the present invention. Those skilled in the art are familiar with instructions, processor(s), and storage medium.

The present invention is described above with reference to exemplary embodiments. It will be apparent to those skilled in the art that various modifications may be made and other embodiments can be used without departing from the broader scope of the present invention. Therefore, these and other variations upon the exemplary embodiments are intended to be covered by the present invention.

What is claimed is:

1. A system for transferring an electronic media, comprising:
a transfer module configured to receive a command to transfer the electronic media from a first location to a second location; and
a graphics module configured to create a copy of the electronic media at the second location.

2. The system of claim 1 further comprising a user preferences module configured to incorporate information based on a user preference into the copy of the electronic media.

3. The system of claim 1 further comprising a media provider data module configured to incorporate real-time media provider information into the copy of the electronic media.

4. The system of claim 1 wherein the first location or the second location is a desktop of a computing device.

5. The system of claim 1 wherein the first location or the second location is an e-mail communication.

6. The system of claim 1 wherein the first location or the second location is a website.

7. The system of claim 1 wherein the first location or the second location is a banner media location.

8. The system of claim 1 further comprising a customization module configured to maintain user preferences.

9. A method for transferring an electronic media comprising:
receiving a command from a user to transfer the electronic media from a first location to a second location; and
generating a version of the electronic media at the second location.

10. The method of claim 9 wherein generating the version comprises generating a copy of the electronic media.

11. The method of claim 9 wherein generating the version comprises generating a link to a version of the electronic media.

12. The method of claim 9 further comprising receiving real-time media provider information and incorporating the real-time media provider information into the version of the electronic media.

13. The method of claim 9 further comprising customizing the version of the electronic media according to user preferences.

14. The method of claim 9 wherein the command comprises a drag and drop command.

15. The method of claim 9 wherein the command comprises a copy and paste command.

16. The method of claim 9 wherein the command is an activation of a script associated with the electronic media.

17. The method of claim 9 wherein the first location or second location is a desktop of a computing device.

18. The method of claim 9 wherein the first location or second location is a banner media location.

19. The method of claim 9 wherein the first location or second location is an email communication.

20. The method of claim 9 wherein the first location or the second location is a website.

21. The method of claim 9 wherein the command comprises an activation of a script in the electronic media.

22. A machine readable medium having embodied thereon a program, the program being executable to provide a method for transferring an electronic media, the method comprising:
receiving a command from a user to transfer the electronic media from a first location to a second location; and
generating a link to a version of the electronic media at the second location.
